(19) United States
(12) Patent Application Publication
(10) Pub. No.: US 2022/0325368 A1
(43) Pub. Date: Oct. 13, 2022

(54) METHOD OF DYNAMIC CONTROL FOR BOTTOM BLOWING O2-CO2-CaO CONVERTER STEELMAKING PROCESS

(71) Applicant: University of Science and Technology Beijing, Beijing (CN)

(72) Inventors: Rong ZHU, Beijing (CN); Weifeng LI, Beijing (CN); Guangsheng WEI, Beijing (CN); Chao FENG, Beijing (CN); Kai DONG, Beijing (CN); Runzao LIU, Beijing (CN); Yun ZHOU, Beijing (CN); Qiang RUAN, Jiayuguan City, Gansu Province (CN); Guoli WEI, Jiayuguan City, Gansu Province (CN); Deyong WANG, Jiayuguan City, Gansu Province (CN); Qingde ZHU, Jiayuguan City, Gansu Province (CN); Zhiguo HAN, Jiayuguan City, Gansu Province (CN)

(21) Appl. No.: 17/440,648

(22) PCT Filed: Aug. 11, 2020
(86) PCT No.: PCT/CN2020/108455

§ 371 Date: Sep. 17, 2021

(30) Foreign Application Priority Data
May 28, 2020 (CN) 202010469302.9

(51) Int. Cl. C21C 5/35; C21C 7/00

(52) U.S. Cl. CPC C21C 5/35; C21C 7/0037; C21C 2300/06

(57) ABSTRACT

There is provided a method of dynamic control for a bottom blowing O₂—CO₂—CaO converter steelmaking process. In the process, O₂ is adopted as a top blowing gas, a mixed gas O₂+CO₂ is adopted as a bottom blowing carrier gas to inject lime powders into the converter from a bottom blowing tuyere. The ingredients of the molten steel in the converter steelmaking process are predicted based on the conservation of matter, in combination with the ingredient data of charged molten iron, the ingredient data of the converter gas in the converter blowing process, and working conditions of the bottom blowing device. The top blowing oxygen amount, the bottom blowing gas ratio and the flow rate of lime powder are dynamically adjusted stage by stage according to requirements for target ingredients at the end point of blowing.

### TECHNICAL FIELD

The present disclosure relates to the technical field of steelmaking process, in particular to a method of dynamic control for a bottom blowing O₂—CO₂—CaO converter steelmaking process.

### BACKGROUND

Molten iron and scrap-metal having various ingredients may be treated by converter steelmaking processes, in which charge material may be adjusted flexibly. Further, a converter steelmaking process exhibits a short blowing period and a great production capacity. Therefore, it has become the most popular steelmaking method in the world. The converter steelmaking process may provide better kinetic conditions for a metallurgical reaction by using top blowing oxygen as a means for heating and stirring the molten bath, in combination with bottom blowing for enhancing the stirring in the molten bath, so as to produce molten steel achieving the aim carbon content and phosphorus content and having a qualified temperature. However, in conventional converter steelmaking processes, the stirring in the molten bath is not violent enough, and there is still relatively much room for improvement in the metallurgical effect and the steelmaking costs. A bottom blowing O₂—CaO converter steelmaking process enhances the stirring in the molten bath and achieves a good dephosphorization effect, while it also has a series of problems. 1) Bottom blowing O₂ reacts with silicon element and manganese element in the molten bath during the early blowing stage will produce oxides, which enter the slag, resulting in that the amount of the gas floated up is greatly reduced and the stirring in the molten bath is weak. 2) Although the dephosphorization effect is relatively good, the injection amount of CaO powders is not accurate, and the effective utilization rate thereof still needs to be improved. 3) Although the mixing ratio of bottom blowing CO₂ may reduce the temperature of the bottom blowing fire spot zone, the mixing ratio is not accurate. A too large mixing ratio of bottom blowing CO₂ may cause a low end point temperature, while a too small mixing ratio of bottom blowing CO₂ may fail to achieve the effects of protecting the bottom blowing tuyere and enhancing the stirring in the molten bath.

Chinese Patent Application No. 201810013096.3 discloses a converter steelmaking process, which introduces a converter steelmaking method in the conventional converter steelmaking process, wherein a top blowing oxygen lance cooperates with charging to solve the problem of metal loss when oxygen is supplied at a constant pressure and a variable lance position. In this method, stricter operations during practical blowing process are required, the stirring in the molten bath is limited, and the end point ingredients and temperature of the molten steel are not stable.

Therefore, problems to be solved urgently include how to achieve accurate control of the bottom blowing O₂—CO₂—CaO converter steelmaking process, extend the life of the bottom blowing nozzle, enhance the stirring in the molten bath, prevent molten steel from overoxidation, reduce inclusions in steel, decrease the end point phosphorus content, shorten the blowing period, reduce production costs, and exhibit technical advantages of this method sufficiently.

### SUMMARY

Regarding the problems above, the present disclosure proposes a method of dynamic control for a bottom blowing O₂—CO₂—CaO converter steelmaking process, which solves technical problems in the existing conventional converter steelmaking process, such as a large fluctuation of the end point ingredients, overoxidation of the molten steel, and long blowing time. The bottom blowing tuyere of the bottom blowing O₂+CO₂+CaO converter process is concentric tubes with an annular gap. During the blowing process, O₂+CO₂+CaO blow into the molten bath from the center tube of the bottom blowing tuyere, CH₄ blows into the molten bath from the annular gap of the bottom blowing tuyere, and high-speed O₂ blows into the molten bath from the top blowing oxygen lance. The ingredients of the molten steel in the converter steelmaking process are predicted based on the conservation of matter, in combination with the ingredient data of charged molten iron, the ingredient data of the converter gas in the converter blowing process, and working conditions of the bottom blowing device. The blowing process is divided into three stages, including an early stage, a middle stage and a late stage, according to the decarburization rate. The top blowing oxygen amount, the bottom blowing gas ratio and the flow rate of lime powder are dynamically adjusted stage by stage according to requirements for target ingredients at the end point of blowing, so as to promote the equilibrium of the slag-metal reaction, on the basis of enhancing the stirring effect in the molten bath in the converter. Meanwhile, it avoids the overoxidation at the end point of the converter blowing, reduces the consumption of deoxidizing alloy, reduces the quantity of inclusions in steel, improves the quality of molten steel, shortens the converter steelmaking period on the basis of improving the efficiency of the slag-metal reaction, and thus further reduces costs.

The present disclosure is implemented by the following technical solution.

There is proposed a method of dynamic control for a bottom blowing O₂—CO₂—CaO converter steelmaking process, characterized by comprising: dividing the bottom blowing O₂—CO₂—CaO converter blowing process into 3 stages, which are an early stage, a middle stage and a late stage, based on a decarburization rate ν_{c}; calculating a blowing oxygen consumption, a CO₂ ratio and a lime powder injection amount by a data calculation module, based on following parameters: a total charge amount mₜₒₜₐₗ, a temperature of charged molten iron T₀₋₁, a carbon content of charged molten iron [% C]₀₋₁, a silicon content of charged molten iron [% Si]₀₋₁, a scrap-metal ratio γ, a carbon content of scrap steel [% C]₀₋₂, a silicon content of scrap steel [% Si]₀₋₂, a target carbon content [% C]_{f} and a target temperature T_{f}; establishing a blowing operation process of the early stage of blowing by a central control system, based on a constitution of charge material, a molten bath heating rate νᵣ and the decarburization rate ν_{c}; and calculating the decarburization rate ν_{c} by a decarburization rate calculation module in the blowing process, and determining a point of starting time of the middle stage of blowing and a point of starting time of the late stage of blowing, calculating a CO₂ mixing ratio by a CO₂ calculation module by a calculation model for bottom blowing fire spot area temperature and a dephosphorization model, and further establishing a blowing operation process of the middle stage and a blowing operation process of the late stage, so as to decrease a fire spot area temperature, enhance stirring in a molten bath, and promote an equilibrium of slag-metal reaction in a molten bath.

An end point of blowing is determined based on the decarburization rate ν_{c}, and parameters of bottom blowing gas are adjusted, and then the converter is turned down for steel tapping. By using this method, the temperature of the fire spot area may be reduced, and the life of the bottom blowing tuyere may be extended. The stirring in the molten bath may be enhanced according to different stages of blowing. It may achieve purposes of rapid decarburization, efficient dephosphorization and avoiding overoxidation of molten steel, shortening the blowing time, stabilizing ingredients of the molten steel at the end point of blowing, and reducing production costs.

Further, in the bottom blowing O₂—CO₂—CaO converter steelmaking process, a bottom blowing tuyere is concentric tubes with an annular gap, wherein a mixed gas O₂+CO₂ as a carrier gas through a center tube blows lime powders from a bottom of the converter directly into the molten bath, and a cooling protective gas, which may be CH₄, CO₂, N₂, Ar, blows through the annular gap. Ingredients and a temperature of a molten steel in the blowing process are predicted based on ingredients of charge material in the converter and ingredients of a flue gas, a CO₂ mixing amount is calculated by the calculation model for bottom blowing fire spot area temperature and the dephosphorization model according to requirements for ingredients and temperature of target steel, and a ratio of CO₂ in bottom blowing gas is dynamically adjusted stage by stage based on a decarburization rate in the molten bath.

Further, a control step of the method described above is as follows: calculating a lime powder injection rate by a powder calculation module based on requirements for the total charge amount mₜₒₜₐₗ, silicon contents [% Si] and an alkalinity R, wherein a rate of injecting and blowing lime powders is calculated and adjusted through a formula ν_{CαO}·t={[% Si]₀₋₁·(1-γ)+[% Si]₀₋₂·γ}·mₜₒₜₐₗ·R; calculating a converter gas instantaneous production amount S_{o-gas} based on feedback parameters when a top blowing device and a bottom blowing device work, and simultaneously calculating a change of the decarburization rate in the converter blowing process based on converter gas ingredient data, so as to determine a converter blowing stage and respective ingredients of the molten steel; wherein instantaneous contents of CO₂, CO, O₂, H₂ in the converter gas are respectively P_{0-CO2}, P_{0-CO}, P_{0-O2}^{and} P_{0-H2}, a flow rate of top blowing oxygen is Q_{U-O2}, a bottom blowing gas through the center tube is a mixed gas O₂+CO₂, a bottom blowing gas through the annular gap is CH₄, and a total flow rate, a CO₂ ratio and a CH₄ ratio of the bottom blowing gas are respectively Q_{b}, ε_{b-CO2}, ε_{b-cH4}; and calculating and confirming the converter gas flow rate S_{0-gas} according to a formula 2Q_{b}(ε_{b-CH4})=S_{0-gas}·P_{0-H2} and a bottom blowing working parameter, and calculating the decarburization rate by the decarburization rate calculation module. The decarburization rate in the converter blowing process is calculated by a formula

$${v}_{C} = \frac{{d}_{{m}_{c}}}{{d}_{t}} = \frac{12}{22.4} [ ( {P}_{O - {CO}_{2}} + {P}_{O - CO} ) \times {Q}_{o - gas} - {Q}_{b} \times {ε}_{b - {CO}_{2}} ] .$$

Further, control steps of the method described above are specifically as follows:

Step 1: acquiring a constitution of charge material, key ingredient data and a target parameter in the converter by a data collecting system, transmitting the constitution of charge material, the key component data and the target parameter to a data calculation module, and establishing and controlling the blowing operation process of the early stage by the central control system;

Step 2: in the early stage of blowing, lowering a top blowing oxygen lance into the converter to perform oxygen blowing, blowing lime powders into the molten bath through a center tube of a bottom blowing tuyere by using the mixed gas O₂+CO₂ as a carrier gas, CH₄ blowing as a protective gas through a annular gap of the bottom blowing tuyere, and determining an end point of the early stage of blowing based on flue gas ingredient data and the decarburization rate

$${v}_{C} = {( \frac{{d}_{{m}_{c}}}{{d}_{t}} )}_{i}$$

obtained by the decarburization rate calculation module, according to the blowing operation process established in the step 1;

Step 3: in the middle stage of blowing, determining a start time of the middle stage based on the decarburization rate

$${v}_{C} = {( \frac{{d}_{{m}_{c}}}{{d}_{t}} )}_{i} ,$$

obtained in the step 2, and further establishing a middle stage operation process;

Step 4: in the late stage of blowing, determining a start time of the late stage based on the decarburization rate

$${v}_{C} = {( \frac{{d}_{{m}_{c}}}{{d}_{t}} )}_{i} ,$$

calculating the CO₂ ratio mixed in the late stage by using the CO₂ calculation module based on the heating rate ν_{T}, and further establishing a late stage operation process;

Step 5: at an end of blowing, determining a time point, when the blowing process ends, based on the decarburization rate

$${v}_{C} = {( \frac{{d}_{{m}_{c}}}{{d}_{t}} )}_{i} ;$$

Step 6: switching the blowing gas through the center tube to Ar at a flow rate of 2500 to 18400 Nm³/h, switching the blowing gas through the annular gap to Ar at a flow rate of 200 to 1790 Nm³/h, reducing stirring in the molten bath, accelerating separation of slag and iron, and turning the converter down for steel tapping.

Further, the operation process in the early stage of blowing in the Step 2 is specifically as follows: wherein a bottom lime powder injection rate is 300 to 900 kg/min; a flow rate of the top blowing oxygen is 10000 to 63000 Nm³/h, a total flow rate of bottom blowing O₂+CO₂ through the center tube is 3000 to 18900 Nm³/h, in which the CO₂ mixing ratio is 0-100%, a flow rate of the bottom blowing CH₄ through the annular gap is 300 to 1890 Nm³/h, and an end time of blowing is at 3 to 6 min.

Further, the operation process in the middle stage of blowing in the Step 3 is specifically as follows: wherein the bottom lime powder injection rate is 300 to 900 kg/min, and a powder injection stops at 8 to 10 min; a flow rate of the top blowing oxygen is 9000 to 62000 Nm³/h, a flow rate of the bottom blowing O₂ through the center tube is 3000 to 18900 Nm³/h, in which the CO₂ mixing ratio is 0, a flow rate of the bottom blowing CH₄ through the annular gap is 300 to 1890 Nm³/h, and an end time of the middle stage of blowing is at 9 to 13 min.

Further, the operation process s in the late stage of blowing in the Step 4 is specifically as follows: wherein a bottom lime powder injection rate is 0 kg/min; a flow rate of the top blowing oxygen is 9000 to 62000 Nm³/h, a total flow rate of the bottom blowing O₂+CO₂ from the center tube is 3000 to 18900 Nm³/h, in which the CO₂ mixing ratio is 50-100%, a flow rate of the bottom blowing CH₄ through the annular gap is 300 to 1890 Nm³/h, and an end time of the late stage of blowing is at 13 to 18 min.

The present disclosure is suitable for a 30-300t bottom blowing O₂—CO₂—CaO converter smelting process. The present disclosure extends the life of the bottom blowing tuyere, enhances the stirring effect in the molten bath in the converter blowing process, further promotes the equilibrium of the metallurgical reaction, reduces contents of carbon and phosphorus in the molten steel, and improves the quality of the molten steel. The present disclosure also avoids the overoxidation of molten steel at the end point of the converter blowing, reduces the consumption of deoxidizing alloys and ferromanganese alloys, reduces production costs, and shortens the converter smelting period. The end point carbon content is reduced by 0.01 to 0.03%, the oxygen content is reduced by 200 to 400 PPm, the alloy consumption is reduced by 3-8%, the phosphorus content is reduced by 0.005 to 0.010%, the converter production period is shortened by 0.5 to 2 min, and the steel and iron material consumption is reduced by 10 to 80 kg/t. The quality of molten steel is improved and the costs are reduced.

### BRIEF DESCRIPTION OF THE DRAWINGS

FIG. 1 is a logic block diagram of dynamic control in a method of dynamic control for a bottom blowing O₂—CO₂—CaO converter steelmaking process according to the present disclosure.

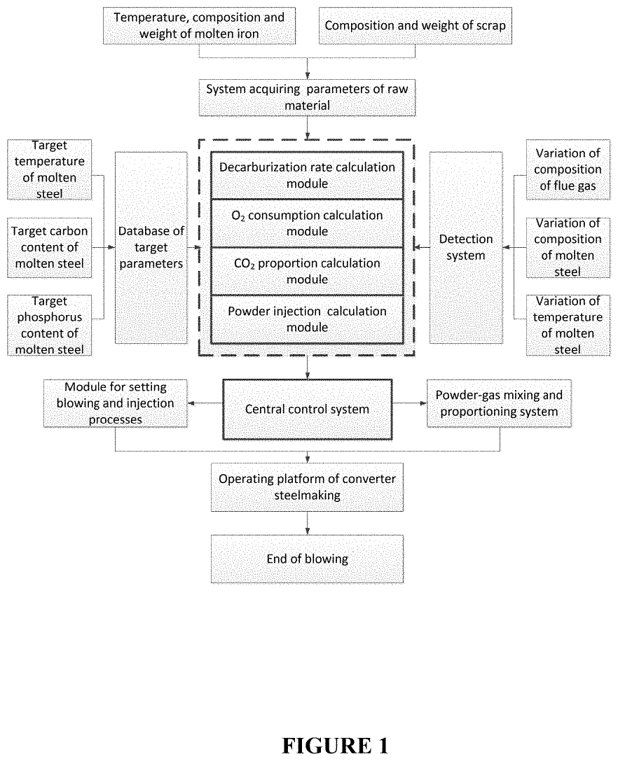

### DETAILED DESCRIPTION OF EMBODIMENTS

In order to make the objectives, technical solutions and advantages of the present disclosure clearer, the present disclosure will be further described in detail below in combination with embodiments. It should be understood that the specific embodiments described here are only used to explain the present disclosure, but not to limit the present disclosure.

Any alternatives, modifications, equivalent methods and schemes defined by the claims in the spirit and scope of the present disclosure are covered by the present disclosure. Further, in order to enable the public to have a better understanding of the present disclosure, in the following detailed description of the present disclosure, some specific details are described in detail. Those skilled in the art may fully understand the present disclosure without the description of these details.

### Example 1

The present disclosure was applied to a 120t bottom blowing O₂—CO₂—CaO converter steelmaking process. The top blowing gas was O₂, the bottom blowing gas through the center tube contained O₂+CO₂, and the bottom blowing protective gas through the annular gap was CH₄. Specific steps were as follows.

1) Following parameters were acquired by a raw material parameter acquisition system and transmitted to a blowing parameter calculation module: a molten iron temperature of 1300° C., a carbon content of molten iron [% C]₀=4.0%, a silicon content of molten iron [% Si]₀=0.60%, a phosphorus content of molten iron [%1]₀=0.109%, a carbon content of scrap steel [% C]₀=0.10%, a silicon content of scrap steel [% Si]₀=0.25%, a phosphorus content of scrap steel [% P]₀=0.020%, a scrap-metal ratio of 15%, a target carbon content of 0.02%, and a target temperature of 1635° C. Then, an operation process of the early stage of blowing was established by a central control system.

2) In the early stage of blowing, according to the operation process formulated in the step 1), oxygen blew from the top. The center tube of the bottom blowing tuyere injected CaO powders into the molten bath, by using the mixed gas O₂+CO₂ as the carrier gas, so as to enhance the stirring in the molten bath and promote slag fusion. CH₄ blew through the annular gap of the bottom blowing tuyere to cool and protect the center tube. The decarburization rate in the molten bath was calculated by the decarburization rate calculation module, and the end time of the early stage of blowing was determined. The specific operation process was as follows. The flow rate of the top blowing oxygen was 19500 Nm³/h, the total flow rate of the bottom blowing mixed gas O₂+CO₂ through the center tube was 7600 Nm³/h, in which the CO₂ mixing ratio was 50%, the lime powder injection rate was 300 kg/min, the flow rate of the bottom blowing gas CH₄ through the annular gap was 760 Nm³/h, and the time of the early stage was at 0 to 5 min.

3) In the middle stage, the start time of the middle stage of blowing was determined to be at 5 min based on the decarburization rate

$${( \frac{{d}_{{m}_{c}}}{{d}_{t}} )}_{i} .$$

Oxygen blew from the top. The center tube of the bottom blowing tuyere injected the CaO powder into the molten bath, by using pure oxygen as the carrier gas, to accelerate a decarburization reaction and enhance the stirring in the molten bath. CH₄ blew through the annular gap to cool and protect the center tube. The specific operation process was as follows. The flow rate of the top blowing oxygen was 17600 Nm³/h, the flow rate of the bottom blowing pure O₂ through the center tube was 7600 Nm³/h, the lime powder injection rate was 300 kg/min, the powder injection stopped at 10 min, the flow rate of the bottom blowing CH₄ through the annular gap was 760 Nm³/h, and the time of the middle stage of blowing was at 5 to 13 min.

4) In the late stage, the start time of the late stage was determined to be at 13 min based the decarburization rate

$${( \frac{{d}_{{m}_{c}}}{{d}_{t}} )}_{i} .$$

Oxygen blew from the top. The mixed gas O₂+CO₂ blew through the center tube of the bottom blowing tuyere to reduce the bottom blowing fire spot area temperature, enhance the stirring in the molten bath and promote the equilibrium of the metallurgical reaction. CH₄ blew through the annular gap to cool and protect the center tube. The specific operation process was as follows. The flow rate of the top blowing oxygen was 20600 Nm³/h, the total flow rate of the bottom blowing mixed gas O₂+CO₂ through the center tube was 7600 Nm³/h, in which the CO₂ mixing ratio was 80%. The flow rate of bottom blowing CH₄ through the annular gap was 760 Nm³/h, and the end time of the late stage of blowing was at 13 to 15 min.

5) At the end point of blowing, it was measured that the temperature was 1635° C., the carbon content of the molten bath was 0.02%, and the oxygen content was 800 PPm. The temperature and ingredients were qualified. The bottom blowing gas through the center tube was switched to pure Ar at a flow rate of 7000 Nm³/h, and the bottom blowing gas through the annular gap was switched to pure Ar at a flow rate of 600 Nm³/h, to reduce the stirring in the molten bath and accelerate a separation of slag and iron. Then the converter was turned down for steel tapping.

### Example 2

The present disclosure was applied to a 300t bottom blowing O₂—CO₂—CaO converter steelmaking process. The top blowing gas was O₂, the bottom blowing gas through the center tube contained O₂+CO₂, and the bottom blowing protective gas through the annular gap was CH₄. Specific steps were as follows.

1) Following parameters were acquired by a raw material parameter acquisition system and transmitted to a blowing parameter calculation module: a molten iron temperature of 1300° C., a carbon content of molten iron [% C]₀=4.0%, a silicon content of molten iron [% Si]o=0.50%, a phosphorus content of molten iron [% P]₀=0.100%, a carbon content of scrap steel [% C]₀=0.15%, a silicon content of scrap steel [% Si]₀=0.20%, a phosphorus content of scrap steel [% P]₀=0.020%, a scrap-metal ratio of 15%, a target carbon content of 0.02%, and a target temperature of 1635° C. Then, an operation process of the early stage of blowing was established by a central control system.

2) In the early stage of blowing, according to the operation process formulated in the step 1), oxygen blew from the top. The center tube of the bottom blowing tuyere injected CaO powders into the molten bath, by using the mixed gas O₂+CO₂ as the carrier gas, so as to enhance the stirring in the molten bath and promote slag fusion. CH₄ blew through the annular gap of the bottom blowing tuyere to cool and protect the center tube. The decarburization rate in the molten bath was calculated by the decarburization rate calculation module, and the end time of the early stage of blowing was determined. The specific operation process was as follows. The flow rate of the top blowing oxygen was 47800 Nm³/h, the total flow rate of the bottom blowing mixed gas O₂+CO₂ through the center tube was 19000 Nm³/h, in which the CO₂ mixing ratio was 40%, the lime powder injection rate was 700 kg/min, the flow rate of the bottom blowing gas CH₄ through the annular gap was 1900 Nm³/h, and the time of the early stage was at 0 to 6 min.

3) In the middle stage, the start time of the middle stage of blowing was determined to be at 6 min based on the decarburization rate

$${( \frac{{d}_{{m}_{c}}}{{d}_{t}} )}_{i} .$$

Oxygen blew from the top. The center tube of the bottom blowing tuyere injected the CaO powder into the molten bath, by using pure oxygen as the carrier gas, to accelerate a decarburization reaction and enhance the stirring in the molten bath. CH₄ blew through the annular gap to cool and protect the center tube. The specific operation process was as follows. The flow rate of the top blowing oxygen was 44000 Nm³/h, the flow rate of the bottom blowing pure O₂ through the center tube was 19000 Nm³/h, the lime powder injection rate was 700 kg/min, the powder injection stopped at 9 min, the flow rate of the bottom blowing CH₄ through the annular gap was 1900 Nm³/h, and the time of the middle stage of blowing was at 6 to 14 min.

4) In the late stage, the start time of the late stage was determined to be at 14 min based the decarburization rate

$${( \frac{{d}_{{m}_{c}}}{{d}_{t}} )}_{i} .$$

Oxygen blew from the top. The mixed gas O₂+CO₂ blew through the center tube of the bottom blowing tuyere to enhance the stirring in the molten bath and promote the equilibrium of the metallurgical reaction. CH₄ blew through the annular gap to cool and protect the center tube. The specific operation process was as follows. The flow rate of the top blowing oxygen was 50600 Nm³/h, the total flow rate of the bottom blowing mixed gas O₂+CO₂ through the center tube was 19000 Nm³/h, in which the CO₂ mixing ratio was 70%. The flow rate of bottom blowing CH₄ through the annular gap was 1900 Nm³/h, and the end time of the late stage of blowing was at 14 to 17 min.

5) At the end point of blowing, it was measured that the temperature was 1637° C., the carbon content of the molten bath was 0.02%, and the oxygen content was 750 PPm. The bottom blowing gas through the center tube was switched to pure Ar at a flow rate of 49000 Nm³/h, and the bottom blowing gas through the annular gap was switched to pure Ar at a flow rate of 1300 Nm³/h, to reduce the stirring in the molten bath and accelerate a separation of slag and iron. Then the converter was turned down for steel tapping.

The specific embodiments of the present disclosure described above do not constitute a limitation on the protection scope of the present disclosure. Any other corresponding changes and modifications made according to the technical concept of the present disclosure should be included in the protection scope of the claims of the present disclosure.

1. A method of dynamic control for a bottom blowing O₂—CO₂—CaO converter steelmaking process, comprising:
dividing the bottom blowing O₂—CO₂—CaO converter blowing process into 3 stages, which are an early stage, a middle stage and a late stage, based on a decarburization rate ν_{c};
calculating a blowing oxygen consumption, a CO₂ ratio and a lime powder injection amount by a data calculation module, based on following parameters: a total charge amount mₜₒₜₐₗ, a temperature of charged molten iron T₀₋₁, a carbon content of charged molten iron [% C]₀₋₁, a silicon content of charged molten iron [% Si]₀₋₁, a scrap-metal ratio γ, a carbon content of scrap steel [% C]₀₋₂, a silicon content of scrap steel [% Si]₀₋₂, a target carbon content [% C]_{f} and a target temperature T_{f};
establishing a blowing operation process of the early stage of blowing by a central control system, based on a constitution of charge material, a molten bath heating rate νᵣ and the decarburization rate ν_{c}; and
calculating the decarburization rate ν_{c} by a decarburization rate calculation module in the blowing process, and determining a point of starting time of the middle stage of blowing and a point of starting time of the late stage of blowing, calculating a CO₂ mixing ratio by a CO₂ calculation module by a calculation model for bottom blowing fire spot area temperature and a dephosphorization model, and further establishing a blowing operation process of the middle stage and a blowing operation process of the late stage, so as to decrease a fire spot area temperature, enhance stirring in a molten bath, and promote an equilibrium of slag-metal reaction in a molten bath.

2. The method of dynamic control for the bottom blowing O₂—CO₂—CaO converter steelmaking process according to claim 1, wherein in the bottom blowing O₂—CO₂—CaO converter steelmaking process, a bottom blowing tuyere comprises concentric tubes with an annular gap, wherein a mixed gas O₂+CO₂ as a carrier gas through a center tube blows lime powders from a bottom of the converter directly into the molten bath, and a cooling protective gas, including CH₄, CO₂, N₂, Ar, blows through the annular gap; wherein ingredients and a temperature of a molten steel in the blowing process are predicted based on ingredients of charge material in the converter and ingredients of a flue gas, a CO₂ mixing amount is calculated by the calculation model for bottom blowing fire spot area temperature and the dephosphorization model according to requirements for ingredients and temperature of target steel, and a ratio of CO₂ in bottom blowing gas is dynamically adjusted stage by stage based on a decarburization rate in the molten bath.

3. The method of dynamic control for the bottom blowing O₂—CO₂—CaO converter steelmaking process according to claim 1, wherein a control step is as follows:
calculating a lime powder injection rate by a powder calculation module based on requirements for the total charge amount mₜₒₜₐₗ, silicon contents [% Si] and an alkalinity R, wherein a rate of injecting and blowing lime powders is calculated and adjusted through a formula ν_{cαo}·t={[% Si]₀₋₁·(1−γ)+[% Si]₀₋₂·γ}·mₜₒₜₐₗ·R;
calculating a converter gas instantaneous production amount S _{O-gas} based on feedback parameters when a top blowing device and a bottom blowing device work, and simultaneously calculating a change of the decarburization rate in the converter blowing process based on converter gas ingredient data, so as to determine a converter blowing stage and respective ingredients of the molten steel; wherein instantaneous contents of CO₂, CO, O₂, H₂ in the converter gas are respectively P_{0-CO2}, P_{0-CO}, P_{0-O2} and P_{0-H2}, a flow rate of top blowing oxygen is Q_{U-O2}, a bottom blowing gas through the center tube is a mixed gas O₂+CO₂, a bottom blowing gas through the annular gap is CH₄, and a total flow rate, a CO₂ ratio and a CH₄ ratio of the bottom blowing gas are respectively Q_{b}, ε_{b-CO2}, ε_{b-CH4}; and
calculating and confirming the converter gas flow rate S_{O-gas} according to a formula 2Q_{b}(ε_{b-CH4})=S_{o-gas}·P_{O-H2} and a bottom blowing working parameter, and calculating the decarburization rate by the decarburization rate calculation module.

4. The method of dynamic control for the bottom blowing O₂—CO₂—CaO converter steelmaking process according to claim 3, wherein the decarburization rate in the converter blowing process is calculated by a formula
$${v}_{C} = \frac{{d}_{{m}_{c}}}{{d}_{t}} = \frac{12}{22.4} [ ( {P}_{O - {CO}_{2}} + {P}_{O - CO} ) ⨯ {Q}_{o - gas} - {Q}_{b} ⨯ {ε}_{b - {CO}_{2}} ] .$$

5. The method of dynamic control for the bottom blowing O₂—CO₂—CaO converter steelmaking process according to claim 1, wherein control steps are specifically as follows:
Step 1: acquiring a constitution of charge material, key ingredient data and a target parameter in the converter by a data collecting system, transmitting the constitution of charge material, the key component data and the target parameter to a data calculation module, and establishing and controlling the blowing operation process of the early stage by the central control system;
Step 2: in the early stage of blowing, lowering a top blowing oxygen lance into the converter to perform oxygen blowing, blowing lime powders into the molten bath through a center tube of a bottom blowing tuyere by using the mixed gas O₂+CO₂ as a carrier gas, CH₄ blowing as a protective gas through a annular gap of the bottom blowing tuyere, and determining an end point of the early stage of blowing based on flue gas ingredient data and the decarburization rate
$${v}_{C} = {( \frac{{d}_{{m}_{c}}}{{d}_{t}} )}_{i}$$
obtained by the decarburization rate calculation module, according to the blowing operation process established in the step 1;
Step 3: in the middle stage of blowing, determining a start time of the middle stage based on the decarburization rate
$${v}_{C} = {( \frac{{d}_{{m}_{c}}}{{d}_{t}} )}_{i}$$
obtained in the step 2, and further establishing a middle stage operation process;
Step 4: in the late stage of blowing, determining a start time of the late stage based on the decarburization rate
$${v}_{C} = {( \frac{{d}_{{m}_{c}}}{{d}_{t}} )}_{i} ,$$
calculating the CO₂ ratio mixed in the late stage by using the CO₂ calculation module based on the heating rate ∇_{T}, and further establishing a late stage operation process;
Step 5: at an end of blowing, determining a time point, when the blowing process ends, based on the decarburization rate
$${v}_{C} = {( \frac{{d}_{{m}_{c}}}{{d}_{t}} )}_{i} ;$$
Step 6: switching the blowing gas through the center tube to Ar at a flow rate of 2500 to 18400 Nm³/h, switching the blowing gas through the annular gap to Ar at a flow rate of 200 to 1790 Nm³/h, reducing stirring in the molten bath, accelerating separation of slag and iron, and turning the converter down for steel tapping.

6. The method of dynamic control for the bottom blowing O₂—CO₂—CaO converter steelmaking process according to claim 5, wherein the operation process in the early stage of blowing in the Step 2 is specifically as follows: wherein a bottom lime powder injection rate is 300 to 900 kg/min; a flow rate of the top blowing oxygen is 10000 to 63000 Nm³/h, a total flow rate of bottom blowing O₂+CO₂ through the center tube is 3000 to 18900 Nm³/h, in which the CO₂ mixing ratio is 0-100%, a flow rate of the bottom blowing CH₄ through the annular gap is 300 to 1890 Nm³/h, and an end time of blowing is at 3 to 6 min.

7. The method of dynamic control for the bottom blowing O₂—CO₂—CaO converter steelmaking process according to claim 4, wherein the operation process in the middle stage of blowing in the Step 3 is specifically as follows: wherein the bottom lime powder injection rate is 300 to 900 kg/min, and a powder injection stops at 8 to 10 min; a flow rate of the top blowing oxygen is 9000 to 62000 Nm³/h, a flow rate of the bottom blowing O₂ through the center tube is 3000 to 18900 Nm³/h, in which the CO₂ mixing ratio is 0, a flow rate of the bottom blowing CH₄ through the annular gap is 300 to 1890 Nm³/h, and an end time of the middle stage of blowing is at 9 to 13 min.

8. The method of dynamic control for the bottom blowing O₂—CO₂—CaO converter steelmaking process according to claim 5, wherein the operation process s in the late stage of blowing in the Step 4 is specifically as follows: wherein a bottom lime powder injection rate is 0 kg/min; a flow rate of the top blowing oxygen is 9000 to 62000 Nm³/h, a total flow rate of the bottom blowing O₂+CO₂ from the center tube is 3000 to 18900 Nm³/h, in which the CO₂ mixing ratio is 50-100%, a flow rate of the bottom blowing CH₄ through the annular gap is 300 to 1890 Nm³/h, and an end time of the late stage of blowing is at 13 to 18 min.

9. The method of dynamic control for the bottom blowing O₂—CO₂—CaO converter steelmaking process according to claim 4, wherein control steps are specifically as follows:
Step 1: acquiring a constitution of charge material, key ingredient data and a target parameter in the converter by a data collecting system, transmitting the constitution of charge material, the key component data and the target parameter to a data calculation module, and establishing and controlling the blowing operation process of the early stage by the central control system;
Step 2: in the early stage of blowing, lowering a top blowing oxygen lance into the converter to perform oxygen blowing, blowing lime powders into the molten bath through a center tube of a bottom blowing tuyere by using the mixed gas O₂+CO₂ as a carrier gas, CH₄ blowing as a protective gas through a annular gap of the bottom blowing tuyere, and determining an end point of the early stage of blowing based on flue gas ingredient data and the decarburization rate
$${v}_{C} = {( \frac{{d}_{{m}_{c}}}{{d}_{t}} )}_{i}$$
obtained by the decarburization rate calculation module, according to the blowing operation process established in the step 1;
Step 3: in the middle stage of blowing, determining a start time of the middle stage based on the decarburization rate
$${v}_{C} = {( \frac{{d}_{{m}_{c}}}{{d}_{t}} )}_{i}$$
obtained in the step 2, and further establishing a middle stage operation process;
Step 4: in the late stage of blowing, determining a start time of the late stage based on the decarburization rate
$${v}_{C} = {( \frac{{d}_{{m}_{c}}}{{d}_{t}} )}_{i} ,$$
calculating the CO₂ ratio mixed in the late stage by using the CO₂ calculation module based on the heating rate ν_{T}, and further establishing a late stage operation process;
Step 5: at an end of blowing, determining a time point, when the blowing process ends, based on the decarburization rate
$${v}_{C} = {( \frac{{d}_{{m}_{c}}}{{d}_{t}} )}_{i} ;$$
and
Step 6: switching the blowing gas through the center tube to Ar at a flow rate of 2500 to 18400 Nm³/h, switching the blowing gas through the annular gap to Ar at a flow rate of 200 to 1790 Nm³/h, reducing stirring in the molten bath, accelerating separation of slag and iron, and turning the converter down for steel tapping.

10. The method of dynamic control for the bottom blowing O₂—CO₂—CaO converter steelmaking process according to claim 9, wherein the operation process in the early stage of blowing in the Step 2 is specifically as follows: wherein a bottom lime powder injection rate is 300 to 900 kg/min; a flow rate of the top blowing oxygen is 10000 to 63000 Nm³/h, a total flow rate of bottom blowing O₂+CO₂ through the center tube is 3000 to 18900 Nm³/h, in which the CO₂ mixing ratio is 0-100%, a flow rate of the bottom blowing CH₄ through the annular gap is 300 to 1890 Nm³/h, and an end time of blowing is at 3 to 6 min.

11. The method of dynamic control for the bottom blowing O₂—CO₂—CaO converter steelmaking process according to claim 9, wherein the operation process s in the late stage of blowing in the Step 4 is specifically as follows: wherein a bottom lime powder injection rate is 0 kg/min; a flow rate of the top blowing oxygen is 9000 to 62000 Nm³/h, a total flow rate of the bottom blowing O₂+CO₂ from the center tube is 3000 to 18900 Nm³/h, in which the CO₂ mixing ratio is 50-100%, a flow rate of the bottom blowing CH₄ through the annular gap is 300 to 1890 Nm³/h, and an end time of the late stage of blowing is at 13 to 18 min.
